(19) United States
(12) Patent Application Publication
(10) Pub. No.: US 2008/0255923 A1
(43) Pub. Date: Oct. 16, 2008

(54) Virtual Marketing Assistant

(76) Inventors: Daniel Sullivan, Boise, ID (US); Jacob Nordby, Boise, ID (US); Nathan Nordby, Boise, ID (US); Benjamin H. Price, Boise, ID (US)

Correspondence Address: ORMISTON & MCKINNEY, PLLC, P.O. BOX 298, 802 W. Bannock, Ste. 402, BOISE, ID, 83701, US

(21) Appl. No.: 11/735,593

(22) Filed: Apr. 16, 2007

(51) Int. Cl. G06F 17/30

(52) U.S. Cl. 705/10

(57) ABSTRACT

An embodiment is directed to a marketing method that includes analyzing a customer contact database to identify action contacts. A marketing plan is generated for the action contacts. The marketing plan including a proposed action for each action contact. User interface content having controls for implementing the marketing plan is communicated. Selections entered using the user interface content are received and analyzed to identify marketing actions selected to be implemented. Marketing jobs are assembled for the selected marketing actions. Each marketing job is communicated to a fulfillment vendor.

### BACKGROUND

Small business professionals often do not have the resources for effectively marketing their businesses to existing and potential customers. With limited staff and resources, it can be difficult to remain in communication with potential customers while managing the day-to-day operation of a small business.

### DESCRIPTION OF THE DRAWINGS

FIG. 1 illustrates an exemplary block diagrams of an environment in which embodiments of the present invention can be implemented.

FIGS. 2-7 are block diagrams showing physical and logical components used to implement various embodiments of the present invention.

FIGS. 8-12 illustrate exemplary database structures for use in implementing various embodiments of the present invention.

FIGS. 13-16 are exemplary flow diagram illustrating steps taken in performance of various embodiments of the present invention.

FIGS. 17-26 are exemplary screen displays of various implementations of the present invention.

### DETAILED DESCRIPTION

INTRODUCTION: Small business professionals carry the burden of identifying and creating the sales opportunities while carrying out the day to day tasks of their professions. As a consequence, many small business professionals are too busy “working” to market effectively. Embodiments of the present invention help market services to existing and potential clients with a minimal time commitment.

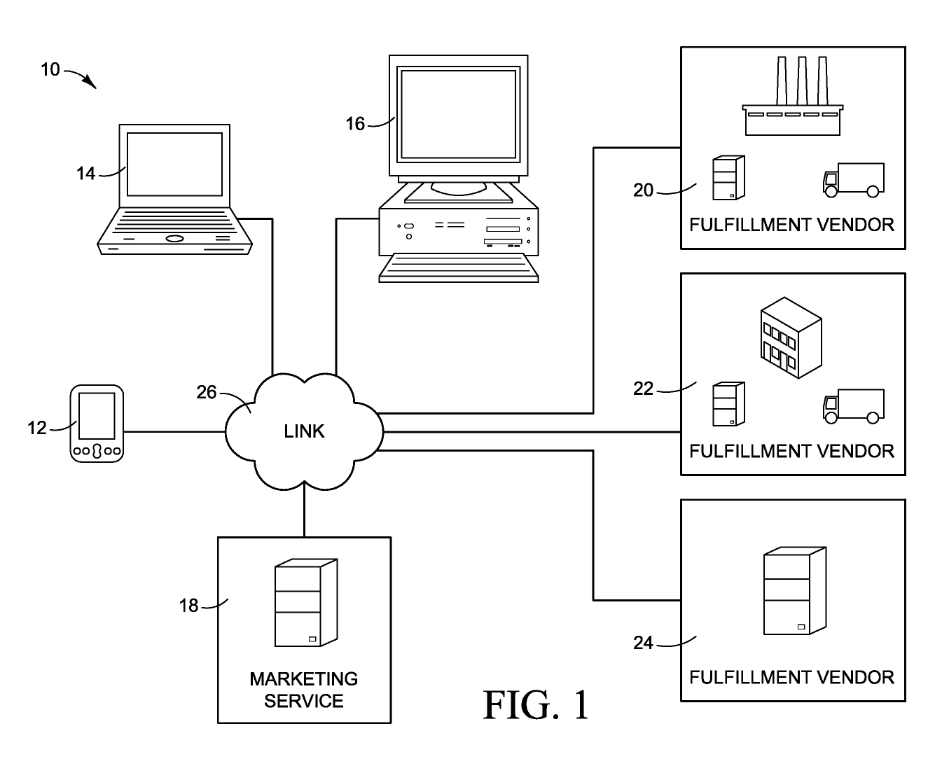

ENVIRONMENT: FIG. 1 illustrates exemplary environment 10 in which various embodiments of the present invention may be implemented. Environment 10 includes customer client devices 12, 14, and 16, marketing service 18, and fulfillment vendors 20, 22, and 24. Customer clients 12, 14, and 16 each represent a computing device capable of displaying information received from marketing service 18 and communicating user selections back to marketing service 18. As an example, a given customer client 12, 14, or 16 may be a personal computer having an internet connection through which information can be exchanged with marketing service 18. Another customer client 12, 14, or 16 may be a smart phone or personal digital assistant having an internet connection through which information can be exchanged with marketing service 18.

Marketing service 18, discussed in more detail below, represents generally a web site and implementing hardware capable of providing an interactive web service capable of providing marketing services. Fulfillment vendors 20, 22, and 24 represent businesses capable of implementing marketing instructions received from marketing service 18. As an example, a given marketing instruction may be for sending a personalized gift, card, e-mail, or letter to a particular recipient on behalf of a particular customer client 12, 14, or 16.

It is noted that while FIG. 1 shows three customer clients 12, 14, and 16 and three fulfillment vendors 20, 22, and 24, environment 10 may include any number of customer clients and any number of fulfillment vendors.

Link 26 interconnects customer client devices 12, 14, and 16, marketing service 18, and fulfillment vendors 20, 22, and 24. link 26 represents generally a cable, wireless, or remote link via a telecommunication link, an infrared link, a radio frequency link, or any other connector or system that provides electronic communication between customer client devices 12, 14, and 16, marketing service 18, and fulfillment vendors 20, 22, and 24. The path followed by link 26 in the schematic view of FIG. 1 represents the logical communication path not necessarily the physical path between customer client devices 12, 14, and 16, marketing service 18, and fulfillment vendors 20, 22, and 24. Customer clients 12, 14, and 16, marketing service 18, and fulfillment vendors 20, 22, and 24 can be connected at any point and the appropriate communication path established logically between the devices.

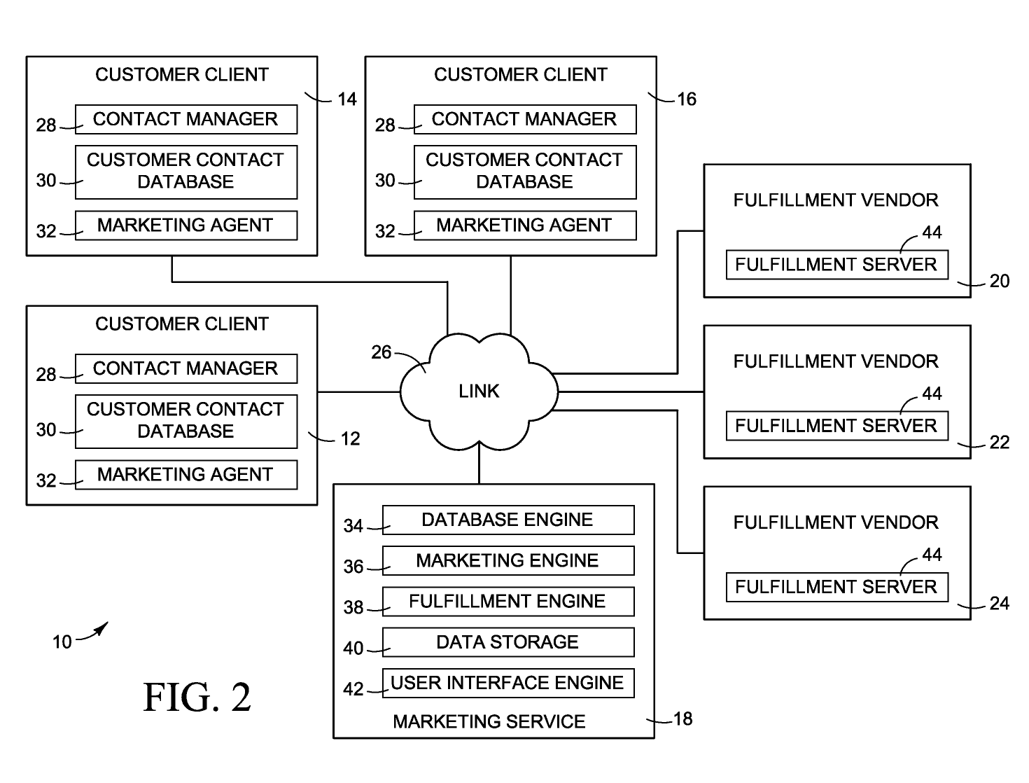

COMPONENTS: FIG. 2 is a block diagram illustrating physical and logical components of used to implement various embodiments. In the example of FIG. 2, each customer client 12, 14, and 16 includes a contact manager 28, a customer contact database 30, and a marketing agent 32. Each contact manager 28 represents generally a software application capable of managing contact information. A given contact manger 28 may be specific to a particular profession or more general in nature. For example, contact manager 28 for customer client device 12 may be designed to manage or contacts for a mortgage broker. Contact manager 28 for customer client device 14 may be designed to manage contacts for an attorney. Contact manager 28 for customer client device 14 may be a more generic PIM (Personal Information Manager) application like Microsoft's Outlook®.

Each customer contact database 30 represents an electronic collection of contact information used by an associated contact manager 28. For example, each customer contact database may be an electronic file or collection of electronic files that can be accessed and parsed by a marketing agent 32.

Each marketing agent 32, discussed in more detail below, represents programming capable of serving as a programmatic interface between marketing service 18 and a given customer contact database 30. For example, a marketing agent 32 may determine that a given customer contact database 30 has been updated and then transmit the updated information to marketing service 18. Each marketing agent 32 is also responsible for causing a given customer client 12, 14, or 16 to display information received from marketing service 18 and to return user selections back to marketing service 18.

For each customer client 12, 14, and 16, it is expected that contact manager 28 and a marketing agent 32 will be stored on one or more computer readable media such as one or more hard drives. A computer processing system having access to the computer readable media will execute the program instructions of each of contact manager 28 and marketing agent 32 to implement their respective functions.

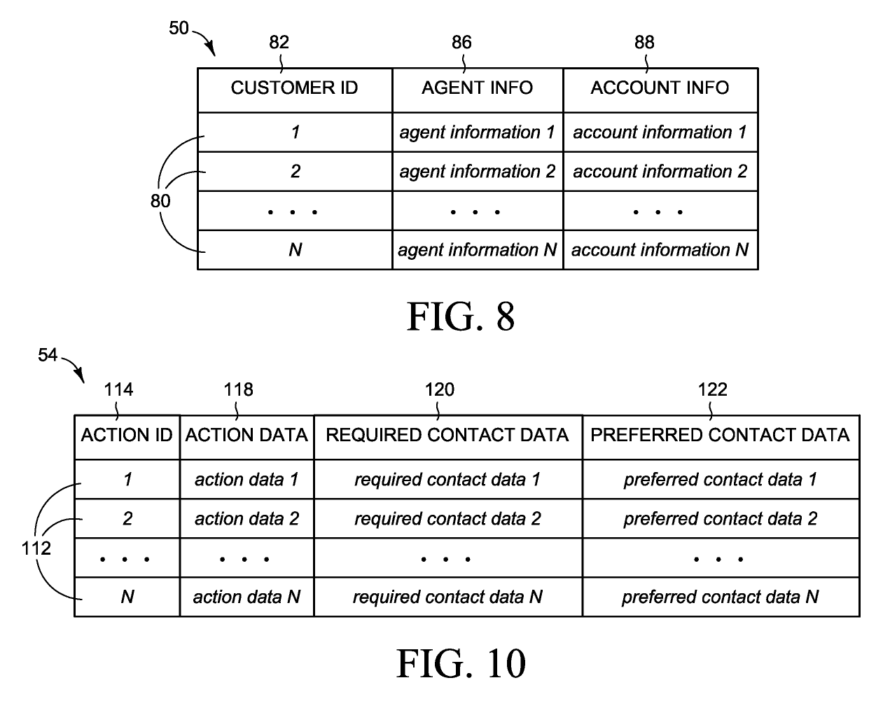

Marketing service 18 is shown to include database engine 34, marketing engine 36, fulfillment engine 38, data storage 40, and user interface engine 42. Data storage 40, discussed in more detail with respect to FIGS. 8-12, represents generally a collection of electronic data utilized by database engine 34, marketing engine 36, and fulfillment engine 38 in the performance of their respective tasks. Database engine 34, discussed in more detail below, represents programming configured to interact with marketing agents 32 and to manage data storage 40. As will be discussed in more detail, database engine 34 is responsible for maintaining a contact database in data storage 40 for each customer client device 12, 14, and 16. Each such contact database in data storage 40 contains at least a subset of the information contained in a corresponding customer contact database 30 and is used to implement marketing actions such as the sending of a personalized letter, e-mail, card or gift. Database engine 34 is responsible for interacting with each marketing agent 32 to populate and update the contact databases in data storage 40 for each customer client device 12, 14, and 16.

Marketing engine 36, discussed in more detail below, represents programming configured to generate a marketing plan based on an examination of a given customer database in data storage 40. A marketing plan is electronic data representing marketing actions for one or more contacts identified from the given customer database. As discussed, marketing actions can include sending a personalized letter, e-mail, card, or gift to a contact. Some marketing actions may be proposed marketing actions meaning that their implementation requires user input or approval. Other marketing actions can be automatic meaning that they are to be implemented without the need for further user intervention. Marketing engine 36 is also responsible for assembling marketing jobs according to the marketing plan and any user input. A marketing job is electronic data containing information that can be interpreted by a particular fulfillment vendor 24 to implement a particular marketing action. Fulfillment engine 38 represents programming configured to communicate marketing jobs to their intended fulfillment vendors 24.

It is expected that database engine 34, marketing engine 36, fulfillment engine 38, and data storage 40 will be stored on one or more computer readable media such as one or more hard drives. A processing system having access to the computer readable media will execute the program instructions of each of database engine 34, marketing engine 36, fulfillment engine 38 to implement their respective functions. As an example, Marketing service may be implemented as a web site accessible via a web server.

User interface engine 42 represents generally any programming capable of being utilized by database engine 34 and marketing engine 36 to communicate with marketing agents 32. As an example, user interface engine 42 may be a web server configured to return requested content from database engine 34 and marketing engine 36 to marketing agents 32 and to pass user input back to database engine 34 and marketing engine 36.

Each fulfillment vendor 24 is shown to include a fulfillment server 44. Each fulfillment server 44 represents programming and hardware configured to receive marketing jobs from fulfillment engine 38. The received marketing jobs are then interpreted to implement various marketing actions. The interpretation and implementation process for each marketing job may be fully automated, partially automated, or manual.

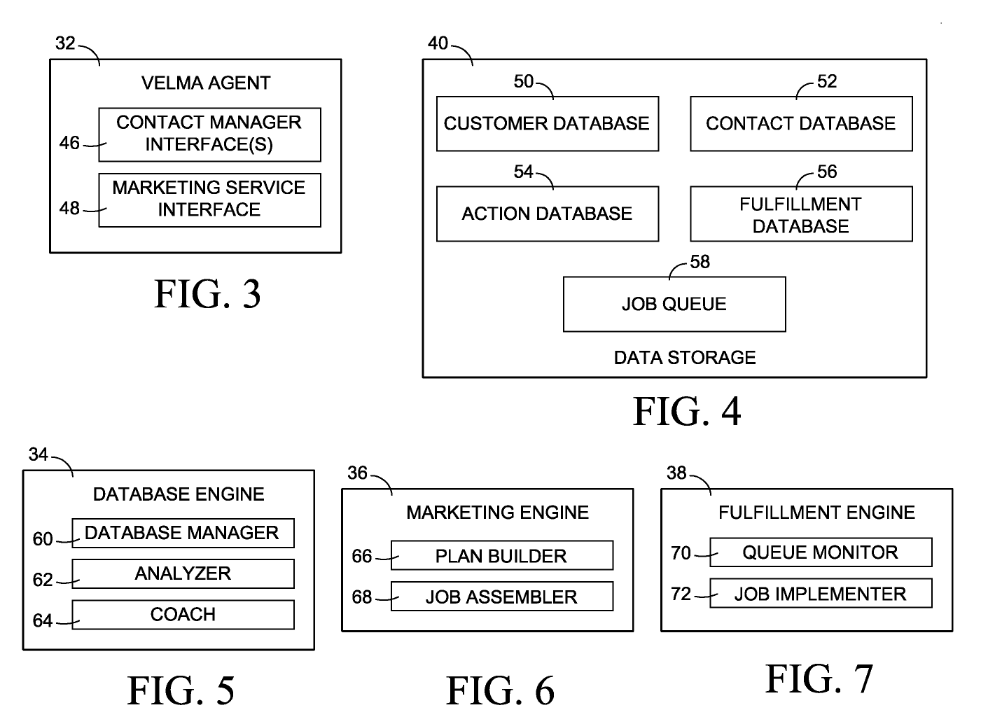

FIG. 3 is a block diagram illustrating the logical components of a marketing agent 32 shown in FIG. 3. In this example, marketing agent 32 includes one or more contact manager interfaces 46 and marketing service interface 48. Each contact manager interface 46 represents generally any programming capable of serving as a programmatic interface with a customer contact database 30 shown in FIG. 2. Each contact manager interface 46 is also configured to communicate the extracted contact information to marketing service 18. A given contact manager interface 46 may be configured to parse and extract specified contact information from a customer contact database 30 of a particular type. As an example, a particular marketing agent 32 may include two contact manager interfaces 46. One may be configured to extract customer information from a customer contact database for a PIM application. The other contact manager interface 44 may be configured to extract contact information from a customer contact database for a business specific application like a billing application designed for a particular profession.

Marketing service interface 48 represents generally any programming capable of presenting a user interface enabling a user of a customer client 12, 14, or 16 to interact with marketing service 18. As an example, marketing service interface 48 may have capabilities similar to that of a web browser in that it can request content from marketing service 18, display that content for a user, and return user input to marketing service 18.

FIG. 4 is a block diagram illustrating the logical structure of data storage 40. In this example, data storage 40 includes customer database 50, contact database 52, action database 54, fulfillment database 56, and job queue 58. Customer database 50 represents a collection of information concerning customers or users of marketing service 18. Contact database 52 represents a collection of contact records for each customer. Referring to FIG. 2 for example, each user of a customer client 12, 14, and 16 can be considered a customer of marketing service 18. Contact database 52 can then be populated with contact information obtained from the users' customer contact databases 30 on customer clients 12, 14, and 16.

Action database 54 represents a collection of action records. An action record is a collection of information that identifies a particular marketing action as well as the types of contact information that is needed or otherwise useful in implementing the identified marketing action.

Fulfillment database 56 represents a collection of fulfillment records. A fulfillment record is a collection of information that identifies a particular fulfillment vendor, the types of marketing actions that can be implemented by that vendor as well as instructions for formatting and communicating data so that the identified fulfillment vendor can implement a desired marketing action. Job queue 58 represents a queue of marketing jobs. A marketing job is electronic data formatted in a manner such that a particular fulfillment vendor can interpret the data to implement a specified marketing action.

FIG. 5 is a block diagram illustrating the logical components of database engine 34 shown in FIG. 3. In this example, database engine 34 includes database manager 60, analyzer 62, and coach 64. Database manager represents programming capable of interacting with data storage 40 (shown in FIG. 7). Such interactions include adding and updating and retrieving contact information. As will be discussed later, contact information is electronic data concerning a particular contact for a particular customer client 12, 14, or 16. For example, customer contact database 30 for customer client 12 can include a series of records with each record containing a collection of contact information for a particular contact. Database manager 60 is responsible for obtaining relevant contact information from customer contact database 30 and updating data storage 40 with that contact information. Relevant contact information is information used to implement a marketing action for a contact. It is noted that data storage 40 can contain contact information not found in a customer contact database 30. In this manner, data storage 40 will contain contact records containing relevant contact information for each customer client 12, 14, and 16.

In performing its functions, database manager 60 can obtain relevant contact information in a number of manners. Database manager 60 can cause user interface engine 42 (shown in FIG. 3) to communicate content such as a web page or other data to a particular customer client's marketing agent 32 to be displayed by that agent's marketing service interface 48. The content provides controls for updating or adding contact information for one or more contacts. User input updating or adding contact information can then be communicated by marketing service interface 48 to database manager 60. Database manger 60 can then use the communicated contact information to update data storage 40.

Database manager 60 can also receive contact information from a marketing agent's contact manager interface 46. As discussed above, each contact manager interface 46 is configured to extract contact information from an associated customer contact database 30. Either on its own or at the request of database manager 60, each contact manager interface 46 communicates extracted contact information to database manager 60. Database manger 60 can then use the communicated contact information to update data storage 40.

Analyzer 62 represents programming configured to parse contact records stored in data storage 40 to identify missing contact information. A customer record in data storage 40 is designed to contain contact information relevant to the implementation of a marketing action. Some bits of contact information may be required to implement a marketing action while other bits may be preferred or otherwise useful. With respect to a particular contact record in data storage 40, that contact record is missing contact information when it is not populated with the all of the contact information that is necessary, desirable, or otherwise useful for implementing a marketing action. Analyzer 62 is also responsible for identifying a completion scale for each contact record contained in data storage 40. A completion scale is data identifying a level of completion with respect to a given contact record in data storage 40.

Missing contact information can include a rank for a contact. A rank is electronic data identifying an importance level of a particular contact with respect to other contacts. Marketing actions for a selected contact may be dependent upon that contacts rank. For example, a high ranking contact may automatically receive a birthday gift while a lower ranking contact might not.

Coach 64 represents programming capable of causing user interface engine 42 to communicate content such as a web page or other data to a particular customer client's marketing agent 32 to be displayed by that agent's marketing service interface 48. The content provides controls for adding missing contact information for one or more contacts. To ease the burden of entering all missing contact information, the content may provide controls for entering a selected subset of that missing information. In other words, the missing contact information may be prioritized so that the selected subset of missing contact information may include only that contact information that is needed to implement one or more upcoming marketing actions. For example, a particular marketing action may be proposed for a contact for which contact information is missing. Coach 64 may then identify a subset t of the missing contact information that is needed to implement the proposed marketing action and cause user interface engine 42 to communicate content that includes controls for only entering that subset of missing contact information.

User input adding contact information can then be communicated by marketing service interface 48 to database manager 60. Database manger 60 can then use the communicated contact information to update data storage 40. Such a process can be repeated until no missing contact information is found.

FIG. 6 is a block diagram illustrating the logical components of marketing engine 36 shown in FIG. 3. In this example, marketing engine 36 is shown to include plan builder 66 and job assembler 68. Plan builder 66 represents programming capable of analyzing contact database 52 (shown in FIG. 4) to identify action contacts and to generate a marketing plan for those action contacts. An action contact is a contact for which a marketing action is to be proposed or automatically implemented. As an example, plan builder 66 may determine that a birthday is approaching for one contact and that a project review date is approaching for another contact. Such contacts may be identified as action contacts. Marketing actions may be selected based on a contact's rank. For example, more elaborate marketing actions may be selected for higher ranking contacts.

As discussed, a marketing plan is a collection of electronic data identifying proposed marketing actions for one or more action contacts. Plan builder 66 is also responsible for causing user interface generator 42 to communicate content such as a web page or other user interface to a particular customer client's marketing agent 32 to be displayed by that agent's marketing service interface 48. The content provides controls for selecting which, if any, of the proposed marketing actions that are to be implemented.

Plan builder 66 is also responsible for identifying automatic marketing actions and proposed marketing actions based on the contact information for the action contacts. As previously discusses, automatic marketing actions are marketing actions that are to be implemented without further user input. For example, contact information for a particular contact may indicate that the contact is to automatically receive a newsletter.

Job assembler 68 represents programming capable of assembling marketing jobs. As previously discussed, a marketing job is electronic data containing information that can be interpreted by a particular fulfillment vendor 24 to implement a particular marketing action. In performing its functions, job assembler 68 assembles marketing jobs for any automatic marketing actions and for those proposed marketing actions selected by a user for implementation. Accordingly, job assembler 68 analyzes selections entered through a user interface communicated to a marketing agent 32 under the direction of plan builder 66. That analysis reveals the proposed marketing actions that are to be implemented.

When assembling a given marketing job for a marketing action, job assembler 68 selects or otherwise identifies a fulfillment vendor 20, 22, or 24 (shown in FIG. 2) that will be responsible for implementing that marketing action. Once identified, job assembler 68 identifies the fulfillment requirements for the selected fulfillment vendor 20, 22, or 24. The fulfillment requirements specify a format for a marketing job. Job assembler 68 then assembles a marketing job according to that format so that the marketing job can be interpreted by the selected fulfillment vendor 20, 22, or 24 in order to implement a specified marketing action. Job assembler 68 then places the assembled marketing job in job queue 58. In addition to the data used by a fulfillment vendor to implement a marketing action, the queued marketing job may also include data identifying the fulfillment vendor 20, 22, or 24 to which the marketing job is to be communicated.

FIG. 7 is a block diagram illustrating the logical components of fulfillment engine 38 shown in FIG. 3. In this example, fulfillment engine 38 is shown to include queue monitor 70 and job implementer 72. Queue monitor 70 represents programming capable of monitoring job queue 58 for the presence of marketing jobs and informing job implementer 72 of the presence of any marketing jobs.

Job implementer 72 represents programming capable of selectively communicating each marketing job from job queue 58 to an identified one of fulfillment vendors 20, 22, or 24. In doing so, job implementer 72 receives an indication of the presence of a marketing job in job queue 58. Based on a first-in-first-out priority, job implementer 72 pulls the next marketing job from job queue 58. The next marketing job is the marketing job within job queue 58 that is next in line to be communicated to a selected one of fulfillment vendors 20, 22, or 24. As discussed above, queued marketing jobs can include data identifying one of fulfillment vendors 20, 22, or 24. Job implementer 72 communicates the pulled marketing job to a fulfillment vendor 20, 22, or 24 identified by the marketing job.

Job implementer may also be responsible for receiving status updates from fulfillment vendors 20, 22, and 24 regarding marketing jobs that have been communicating to fulfillment vendors 20, 22, and 24. For example, a status updates can include information that a particular marketing action defined by a given marketing job has been successfully implemented for a specified contact or an estimated implementation date. Job implementer 72 can then cause database manager 60 to update a contact record for that specified contact in contact database 52 based on that status update.

FIG. 8 is an exemplary block diagram illustrating the logical structure of customer database 50. In this example, customer database includes a number of customer records 80, each customer record 80 corresponding to a particular customer. In this context, a customer may be an individual or enterprise that has subscribed to use marketing service 18. Such a subscription may require the payment of a periodic fee. Each customer record includes a series of fields 82, 86, and 88. Customer ID field 82 contains data such as an alphanumeric string that uniquely identifies a particular customer. Agent info field 86 contains data that identifies the marketing agent installed on a customer client of the identified customer. Such data may be credentials used by that marketing agent to interact with marketing service 18. Account info field 88 contains data such as billing information that can be used to collect fees from the identified customer.

The fees may be subscription fees as well as fees for implementing marketing actions.

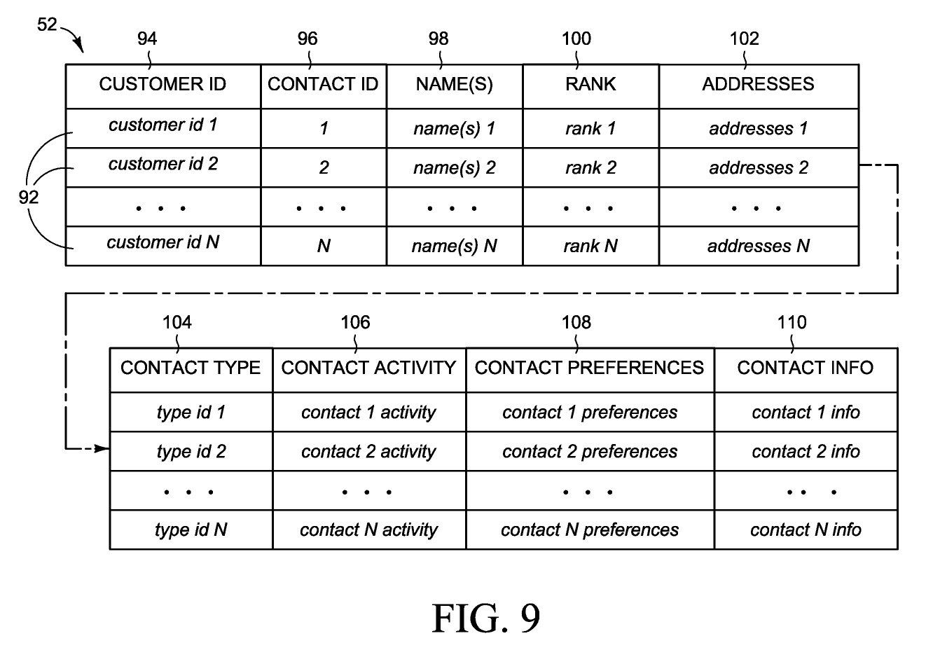

FIG. 9 is an exemplary block diagram illustrating the logical structure of contact database 52. Contact database 52 includes a series of contact records 92. Each contact record 92 includes contact information for a particular contact for a particular customer identified by a record 80 in customer database 50. Each contact record 92 includes a series of fields 94, 96, 98, 100, 102, 104, 106, 108, and 110. Customer ID field 94 contains data that identifies a particular customer record 80 in customer database 50. This data may be the same data found in customer ID field 82 in that customer's record 80. Each contact record 92 that corresponds to that customer would have the same data in customer ID field 94. In this manner contact records 92 can be segregated and identified for each customer.

Contact ID field 96 contains data such as an alphanumeric string that uniquely identifies a particular contact record 92 within contact database 52. Name(s) field 98 contains data identifying the relevant names for a particular contact. These can include the contacts name, the name of the contact's spouse and children, and any other relevant names. Rank field 100 contains data identifying a rank for a given contact. As discussed earlier, such data identifies an importance level of a particular contact with respect to other contacts. Marketing actions selected for a given contact can be dependent upon that contact's rank.

Addresses field 102 contains data identifying various addresses including e-mail addresses for a contact. Contact type field 104 contains data identifying a contact type. Examples of contact types include existing client, prospect, and colleague. Contact activity field 106 contains data identifying marketing actions that have been implemented with respect to the customer. Contact preferences field 108 contains data identifying marketing preferences for a given contact. Such data can include data identifying marketing actions that are to be automatically implemented. Contact info field 110 contains data specific to a given contact such as birthdays, anniversaries, and any other dates that may correspond to a marketing action.

FIG. 10 is an exemplary block diagram illustrating the logical structure of action database 54. Action database 54 includes a series of action records 112. Each action record 112 includes data corresponding to a particular marketing action and includes a series of fields 114, 118, 120, and 122. Action ID field 114 contains data such as an alphanumeric string that uniquely identifies a particular action record 112 within action database 114.

Action data field 118 contains data identifying a particular marketing action. Required contact data field 120 contains data identifying the contact information needed to implement that marketing action. For example, contact information in the form of an address is needed to send a newsletter. In other words, a newsletter cannot be sent to a contact whose associated contact record 92 in contact database 52 is missing address information in address field 102. Similarly, a birthday card cannot be sent to a contact whose associated contact record 92 in contact database 52 is missing a birthday date in contact info field 110. Contact information in the form of a particular rank may also be required. A particular marketing action may be available only for those contacts that have a particular rank. For example all contacts may be eligible to receive a newsletter while only those contacts having a specified rank are eligible to receive birthday cards or gifts.

Preferred contact data field 122 contains data identifying the contact information that can be useful in implementing an identified marketing action. Continuing with the examples above, contact information in the form of the contact's name and spouse's name can be useful in personalizing a newsletter, card, gift, or invitation to an event.

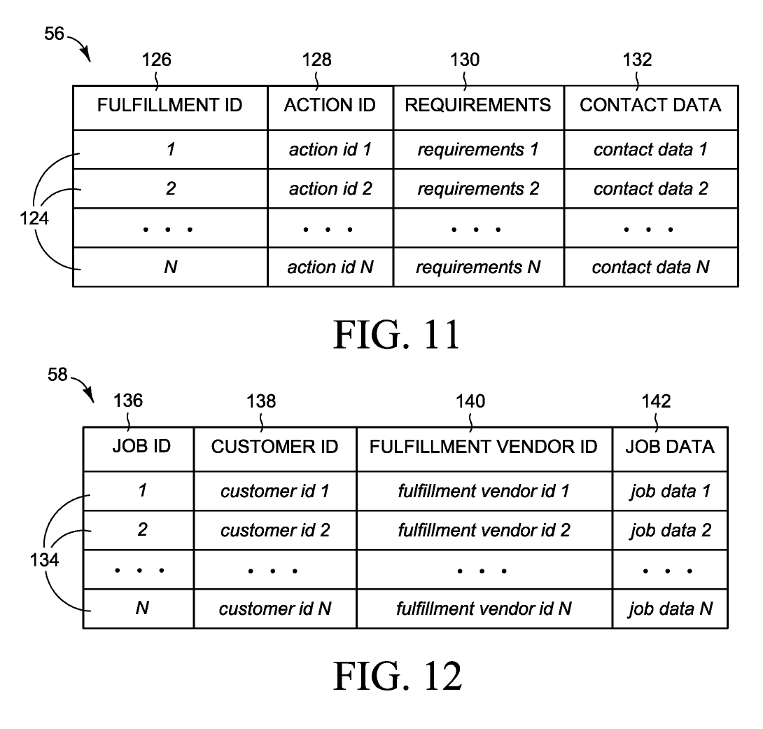

FIG. 11 is an exemplary block diagram illustrating the logical structure of fulfillment database 56. Fulfillment database 56 includes a series of fulfillment records 124. Each fulfillment record 124 includes data corresponding to a particular fulfillment vendor and includes a series of fields 126, 128, 130, and 132. Fulfillment ID field 126 contains data such as an alphanumeric string that uniquely identifies a particular fulfillment vendor.

Action ID field 128 contains data identifying one or more action records 112 in action database 54. This data may be the same data found in action ID fields 114 in those action records 112. For example, a given fulfillment vendor may be capable of implementing two different marketing actions. The fulfillment record 124 for that fulfillment vendor would then contain data in its action ID field 128 that identifies the two action records 112 for those two marketing actions. In this manner when plan builder 66 identifies an action contact and proposes an a marketing action or identifies an automatic marketing action, job assembler 68 can cross reference an action record 112 for the marketing action with fulfillment database 56 to identify and select a fulfillment vendor capable of implementing the marketing action.

Requirements field 130 contains data specifying a format of a marketing job for a given marketing action—the format being interpretable by the fulfillment vendor. For example, such data might identify an application such as a driver or settings for an application pulls contact information from contact record 92 for an action contact and assembles marketing job data. When assembling a marketing job to be communicated to a particular fulfillment vendor, job assembler 68 can access data in requirements field 130 for that vendor and identify the appropriate application or application settings for properly assembling the marketing job for that particular fulfillment vendor.

Contact data field 132 contains data for use in communication with a fulfillment vendor. For example, when assembling a marketing job to be communicated to a particular fulfillment vendor, job assembler 68 can access data in contact data field 132 for that vendor and identify the information such as an e-mail address or web address for communicating a marketing job to that fulfillment vendor.

FIG. 12 is an exemplary block diagram illustrating the logical structure of a job queue 58 populated with marketing jobs 134 assembled by job assembler 68. Each marketing job includes data in fields 136, 138, 140, and 142. Job ID field 136 contains data such as an alphanumeric string that uniquely identifies a particular marketing job within job queue 58.

Customer ID field 138 contains data that identifies a particular customer record 80 in customer database 50. This data may be the same data found in customer ID field 82 in that customer's record 80. Each marketing job 134 for that customer would have the same data in customer ID field 138. In this manner marketing jobs 134 can be segregated and identified for each customer.

Fulfillment vendor ID contains data that identifies a particular fulfillment record 124 in fulfillment database 56. This data may be the same data found in fulfillment ID field 126 in that fulfillment record 124. Each marketing job 134 to be communicated to a particular fulfillment vendor would have the same data in fulfillment vendor ID field 140. In this manner, when queue monitor 70 identifies the presence of a marketing job 134 in job queue 58, job implementer 72 can cross reference data in the fulfillment vendor id field 140 with fulfillment database 56 to identify the particular fulfillment vendor to which the marketing job is to be communicated.

Job data field 142 contains specially formatted data that is to be interpreted by the fulfillment vendor to implement a particular marketing action. For example, this data may include the content of a correspondence such as a newsletter or card and a contact name and address to which the correspondence is to be sent. The data may be formatted by job assembler 68 based on data in requirements field 130 of a fulfillment record 124. Such a format may require that the content of the correspondence be in PDF (Portable Document Format) and the name and address be comma separated entries in a text file. Plainly, a multitude of other formats are possible.

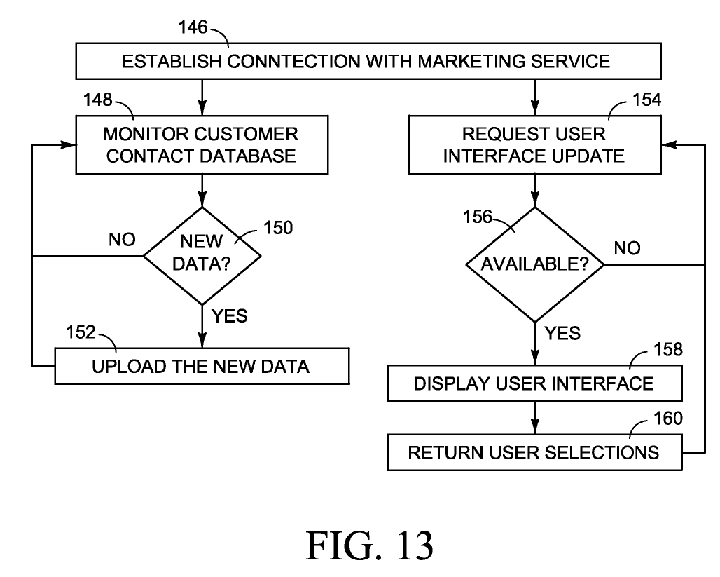

OPERATION: The operation of embodiments of the present invention will now be described with reference to FIGS. 13-16. FIG. 13 is an exemplary flow diagram that helps illustrate actions taken by a marketing agent such as a marketing agent 32 operating on a customer client 12, 14, or 16 (shown in FIG. 2). A marketing agent 32 establishes a connection with marketing service 18 (step 146). This may be accomplished by sending credentials such as a user name and password to marketing service 18. Marketing service 18 can authenticate the credentials and establish the connection. Referring back to FIG. 8, marketing service 18 could cross reference the credentials with data in agent info fields 86 of customer records 80 to identify a particular customer with an active subscription to utilize marketing service 18.

Once a connection is established in step 146, marketing agent 32 operates two separate threads. The first thread is identified by steps 148, 150, and 152. The second thread is identified by steps 154, 156, 158, and 160. In the first thread, marketing agent 32 monitors a customer contact database 30 (step 148) and determines if the database contains new data (step 150). New data may be new or updated contact records in customer contact database 30. If no new data is found, the thread repeats with step 148. If new data is found, marketing agent uploads at least a selected portion of the new data to marketing service 18 (step 152) and the thread repeats with step 148. If only a portion is uploaded, that portion may include contact information necessary or useful in implementing marketing actions. With the uploaded data, marketing service 18 can add new contact records 92 to contact database 52 and update existing contact records 92.

In the second thread, marketing agent 32 requests a user interface update (step 154). For example, marketing agent 32 may send an HTTP request to marketing agent 18. A user interface update is content provided by marketing service 18. The content, for example, may be related to a marketing plan or it may be for providing updated contact information. Marketing agent 32 determines if an interface update is available (step 156). If not available, the second thread jumps to step 154. If a user interface update is available, user interface content is received and displayed (step 158) and selections entered through the user interface are returned to marketing service 18 (step 160). The second thread then jumps back to step 154.

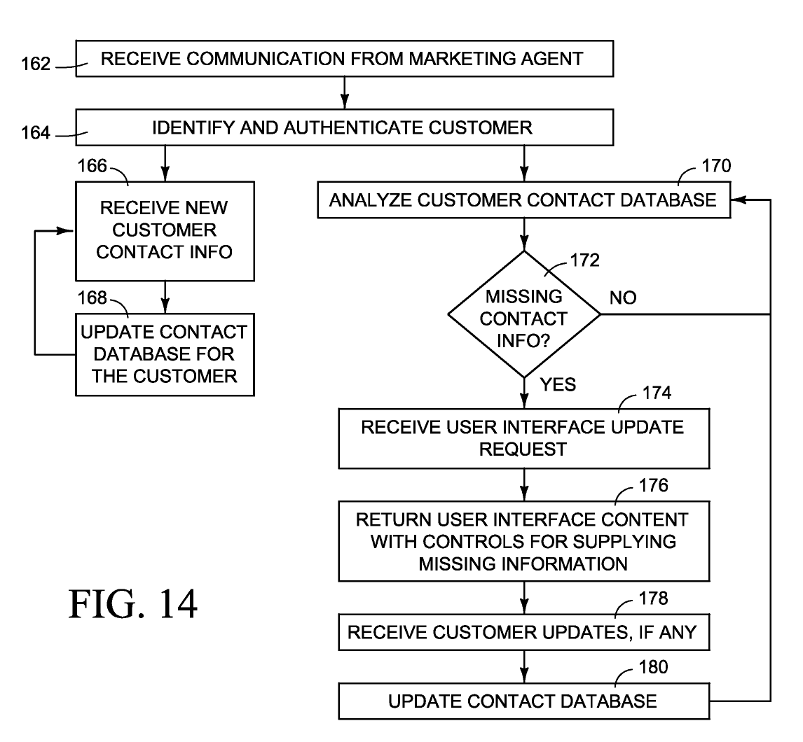

FIG. 14 is an exemplary flow diagram that helps illustrate actions taken by database engine 34 (shown in FIG. 2) in managing contact database 52 (shown in FIG. 4). Database engine 34 receives a communication from marketing agent 32 of a particular customer client 12, 14, or 16 (step 162). Included in that communication are credentials such as a user name and password that identify a customer of marketing service 18. The customer is identified and authenticated (step 164). Step 164 can be accomplished by cross referencing the credentials with customer database 50 to identify a customer and verify that the customer has an active subscription for utilizing marketing service 18.

Once a connection is established in step 146, database manager 34 operates two separate threads. The first thread is identified by steps 166 and 168. The second thread is identified by steps 170, 172, 174, 176, 178, and 180. In the first thread, database engine receives new customer contact information from marketing agent 32 (step 166). Database manager 34 then updates contact database 52 for the customer (step 168). Step 168 may involve adding a new contact record 92 to contact database 52 or updating an existing contact record 92. The first thread then jumps to step 166.

In the second thread, database engine 34 analyzes contact database 52 (step 170) and determines if the fields of any contact records are missing contact information (step 172). As previously discussed missing contact information may be useful or necessary for implementing a marketing action for a particular contact. If not, the second thread jumps back to step 170. If contact information is missing, the thread proceeds with the database engine 34 waiting to receive a user interface update request from marketing agent 32 (step 174). Upon receipt of the update request, database engine 34 causes user interface engine 42 to return user interface content having controls for supplying the missing contact information (step 176). To ease the burden on the customer, the user interface controls may be for only a selected subset of the missing contact information. Customer updates, if any, supplying missing contact information are received (step 178) and database engine 34 updates contact database 52 accordingly (step 180). The second thread then jumps to step 170.

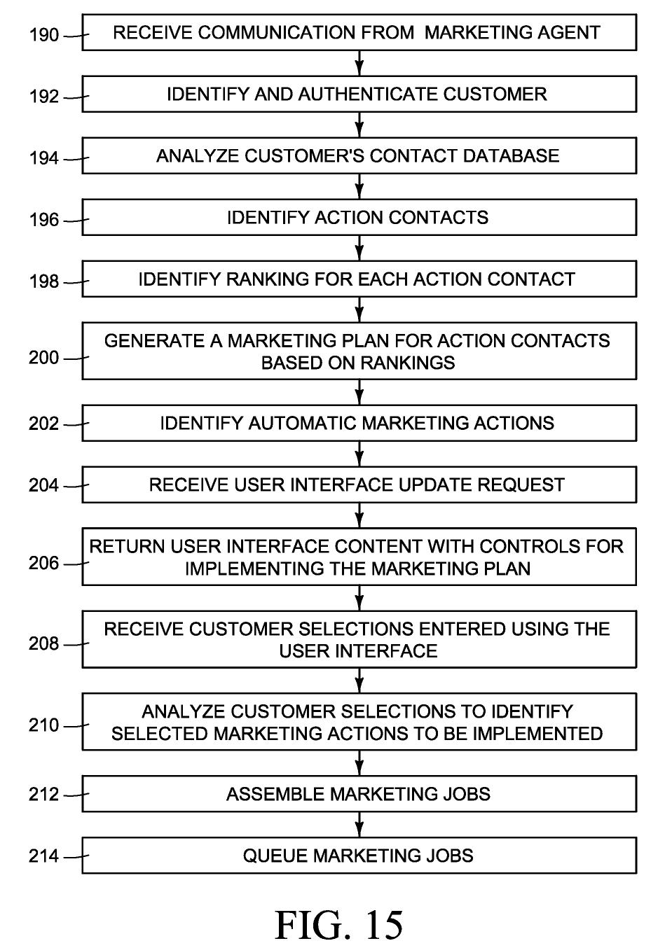

FIG. 15 is an exemplary flow diagram that helps illustrate actions taken by marketing engine 36 (shown in FIG. 2) in generating marketing plans and assembling marketing jobs. Marketing engine 36 receives a communication from marketing agent 32 of a particular customer client 12, 14, or 16 (step 190). Included in that communication are credentials such as a user name and password that identify a customer of marketing service 18. The customer is identified and authenticated (step 192). Step 192 can be accomplished by cross referencing the credentials with customer database 50 to identify a customer and verify that the customer has an active subscription for utilizing marketing service 18.

Marketing engine 36 analyzes contact records 92 for that customer in contact database 52 (step 194) and identifies any action contacts (step 196). As discussed earlier, an action contact is a contact for which a marketing action is to be proposed or automatically implemented. As an example, marketing engine 34 may examine contact database 52 and identify a contact record 92 with contact information indicating that a birthday is approaching for one contact. Marketing engine 34 may identify a second contact record 92 with contact information indicating that a project review date is approaching for another contact. Such contacts may be identified as action contacts.

A ranking for each of the action contacts is identified (step 198). Marketing engine 36 may accomplish step 198 by accessing contact records 92 for each action contact and obtaining data from the rank fields 100 for each of those contact records 92. Marketing engine 36 then generates a marketing plan for the action contacts based on the identified rankings (step 200). The marketing plan is a collection of electronic data identifying proposed marketing actions for one or more action contacts. Proposed marketing actions rely on some form of customer input before they can be implemented. Marketing engine 36 identifies automatic marketing actions for the action contacts (step 202). Automatic marketing actions require no customer input before they are implemented. A contact's ranking can determine the type of marketing action to be proposed or automatically implemented—the higher a contact's rank, the more elaborate the marketing action.

A determination as to whether a marketing action is to be proposed or is automatic can be accomplished following an examination of contact record 92 for the particular action contact. Data found in contact preferences field 108 can identify one or more marketing actions that are to be implemented automatically. Absent an indication that a particular marketing action is to be automatically implemented, that marketing action may instead be proposed as part of a marketing plan.

Marketing engine 35 receives a user interface update request (step 204). Upon receipt of the update request, marketing engine 36 causes user interface engine 42 to return user interface content having controls for implementing one or more of the proposed marketing actions of the marketing plan (step 206). Customer selections, if any, entered using the user interface content are received (step 208). Marketing engine 36 analyzes the customer selections to identify which, if any, of the proposed marketing actions are to be implemented (step 210). Marketing engine 36 assembles marketing jobs for the automatic marketing actions and for any proposed marketing actions selected by the customer (step 212). Marketing engine 36 then queues the assembled marketing jobs in job queue 58 (step 214).

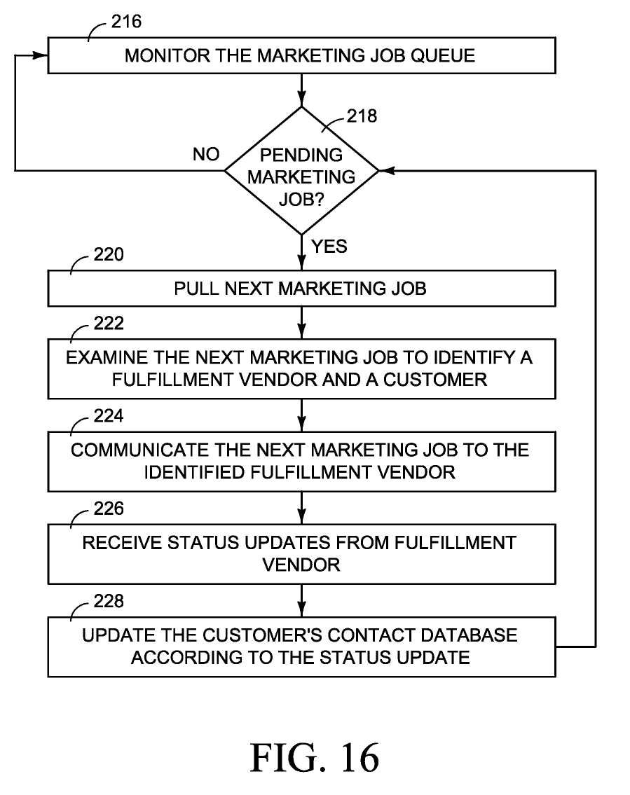

FIG. 16 is an exemplary flow diagram that helps illustrate actions taken by fulfillment engine 38 (shown in FIG. 2) to identify and communicate marketing jobs to various fulfillment vendors. Fulfillment engine 38 monitors job queue 58 (step 216) and identifies any pending marketing jobs 134 (step 218). If no pending marketing jobs 134 exist in job queue 58, the process jumps back to step 216. If job queue 58 contains one or more pending marketing jobs 134, fulfillment engine 38 pulls the next marketing job. The next marketing job is the marketing job 134 within job queue 58 that is next in line to be communicated to a selected one of fulfillment vendors 20, 22, or 24.

Fulfillment engine 38 examines the pulled marketing job 134 to identify a fulfillment vendor 20, 22, or 24 selected to implement the corresponding marketing action and an associated customer (step 222). Fulfillment engine 38 communicates the marketing job 134 to the identified fulfillment vendor (step 226) and receives any status updates regarding the implementation of the corresponding marketing action (step 226). Fulfillment engine 38 then causes the contact database 52 to be updates according to reflect the status update (step 228). Step 228 can involve updating a contact record 92 to include contact information regarding the success or failure of marketing action's implementation.

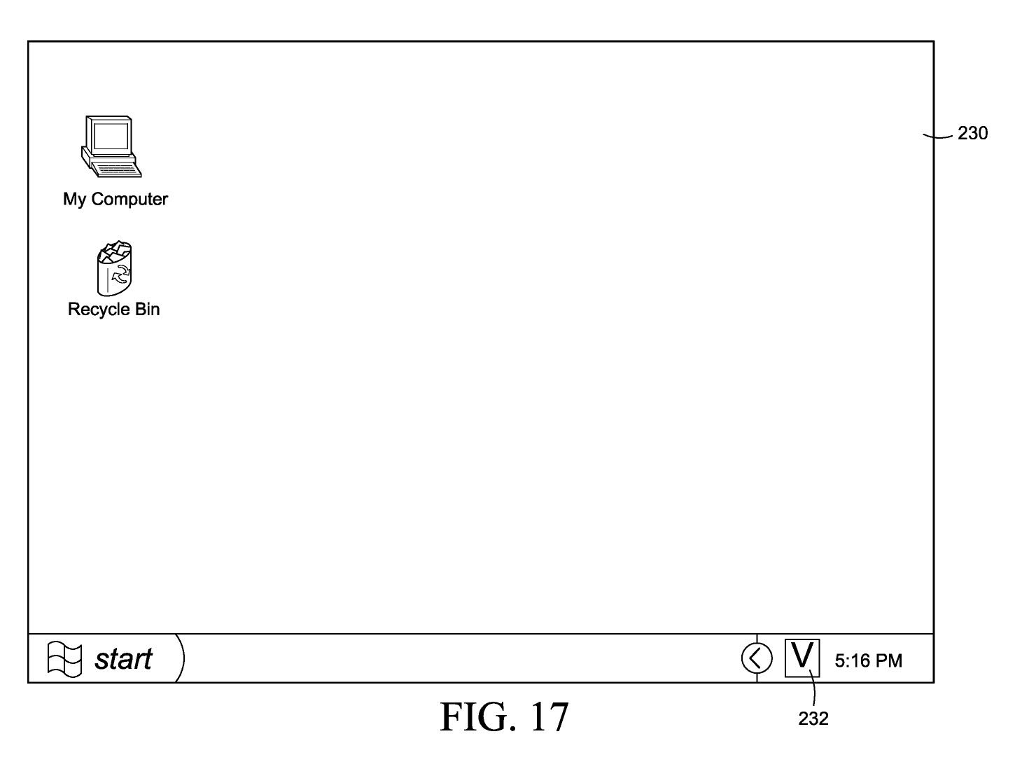

EXEMPLARY IMPLEMENTATION: FIGS. 17-26 are screen views presented to a customer relating to an exemplary implementation of marketing agent 32 and its interaction with marketing service 18. FIG. 17 is an exemplary screen view of a desktop 230 displayed on a customer client 12, 14, or 16. Desktop 230 is shown to include an icon 232. Icon 232 indicates that marketing agent 32 is operating in the background.

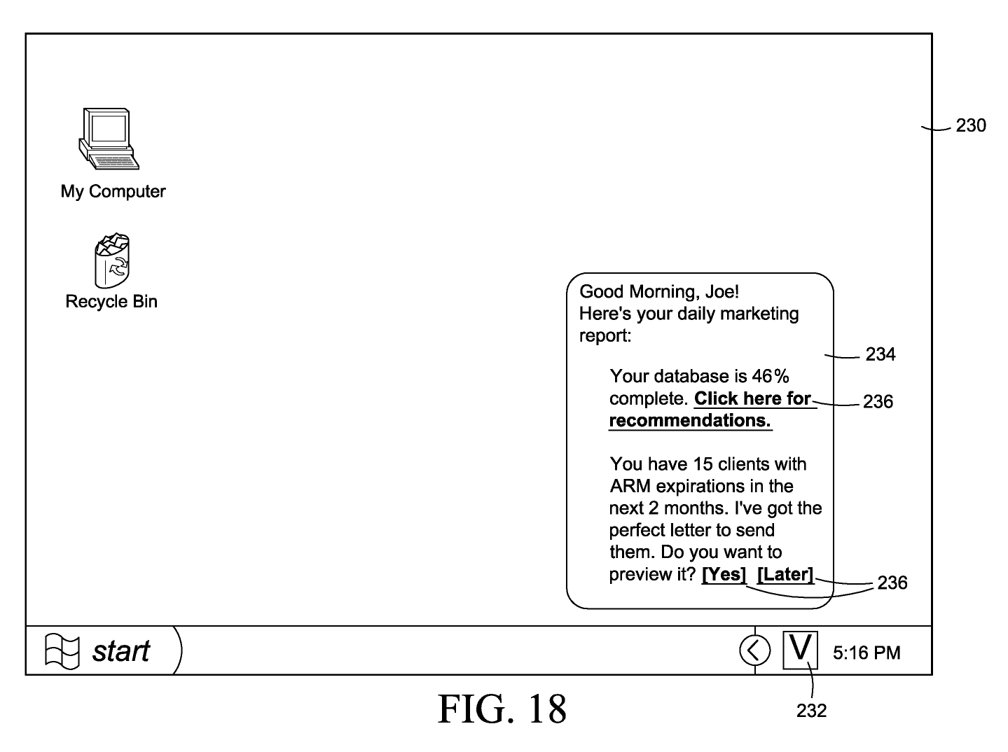

Moving to FIG. 18, marketing agent 32 has received and is causing the display of user interface content 234. User interface content 234 includes controls 236 for updating contact database 52 and controls 236 for beginning the implementation of fifteen proposed marketing actions. In this example, the customer of marketing service 18 is a mortgage broker.

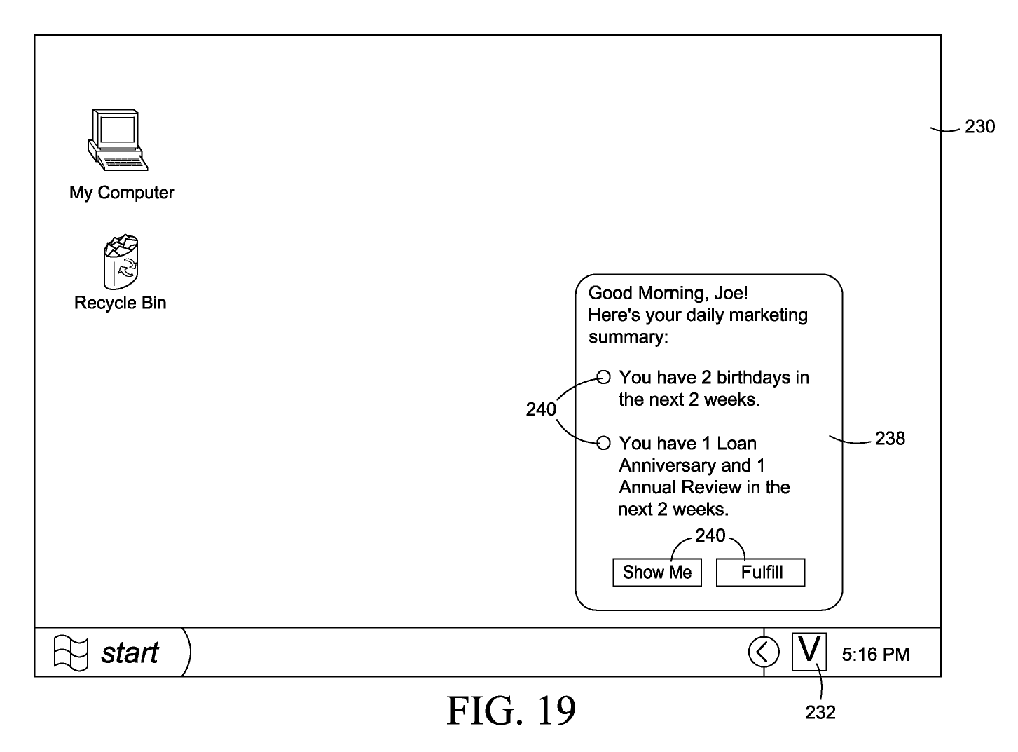

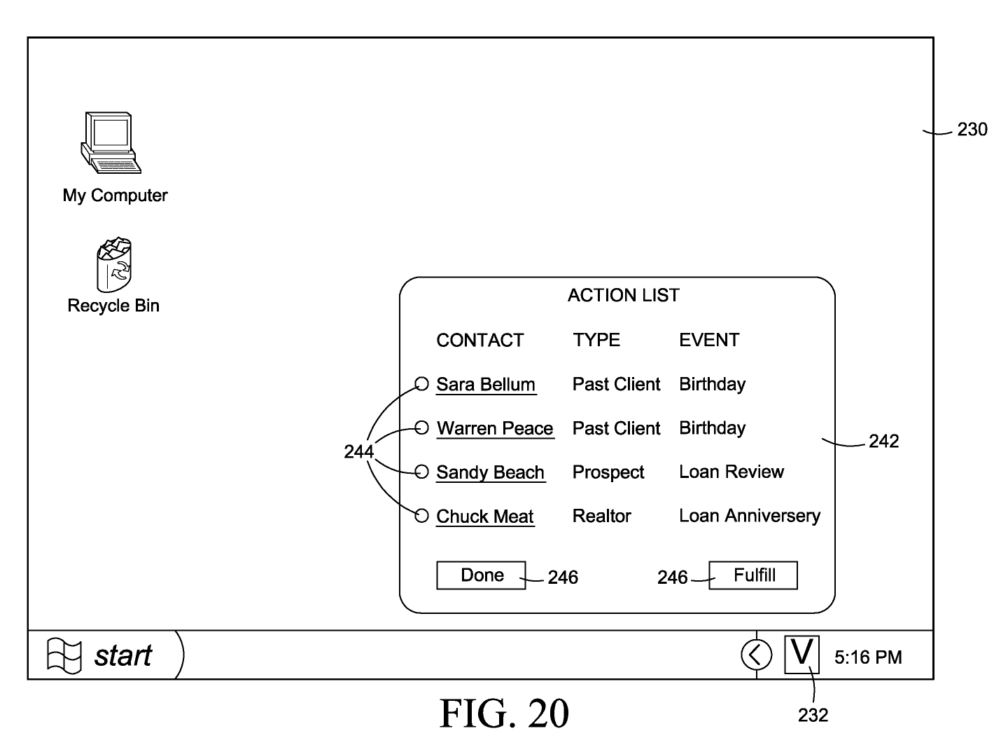

In FIG. 19, marketing agent 32 has received user interface content 238. Content 238 includes controls 240 for implementing proposed marketing actions related to birthdays, loan anniversaries, and an annual review for a particular contact. In FIG. 20, marketing agent 32 has received user interface content 242. Content 242 includes controls 244 and 246 for that more fully explains the marketing actions proposed in FIG. 19. Content 242 is displayed following a section of the “show me” button in FIG. 19. Using controls 244, a user can individually select those marketing actions that are to be implemented. Following such a selection, the user is out of the loop and any selected marketing actions are fulfilled.

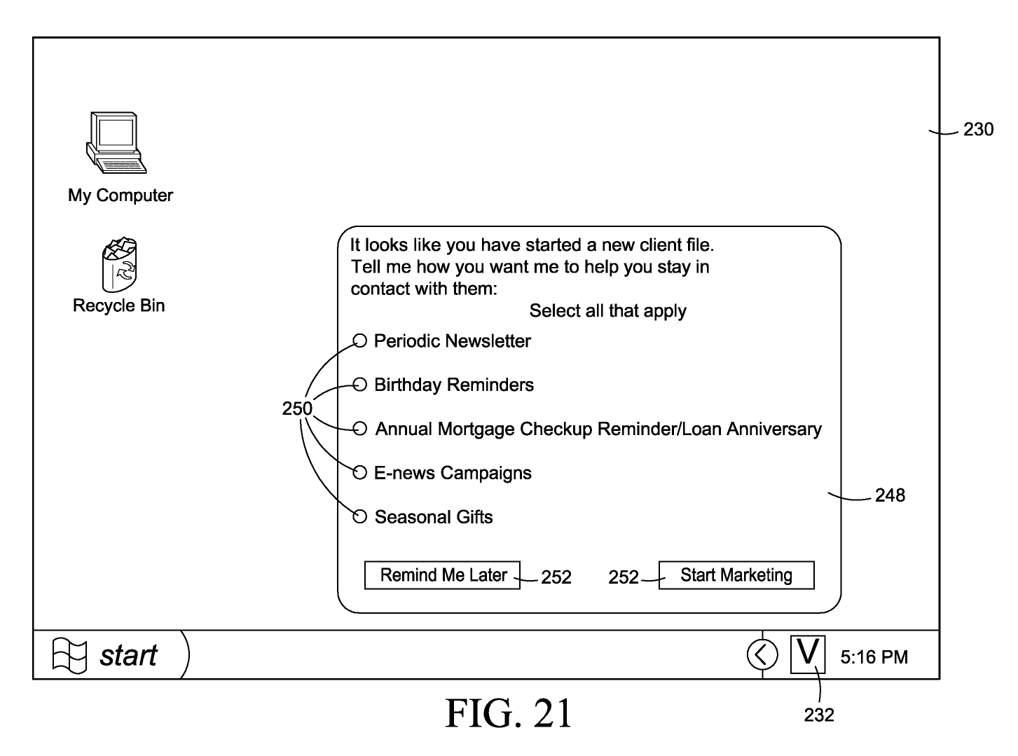

In FIG. 21 marketing agent 32 has received and displayed user interface content 248. Content 248 informs the customer that marketing service 18 has detected that a new contact record 92 has been added for the customer to contact database 52. Content 248 includes controls 250 for selecting marketing actions to be implemented and controls 252 for entering those selections or for asking for a future reminder.

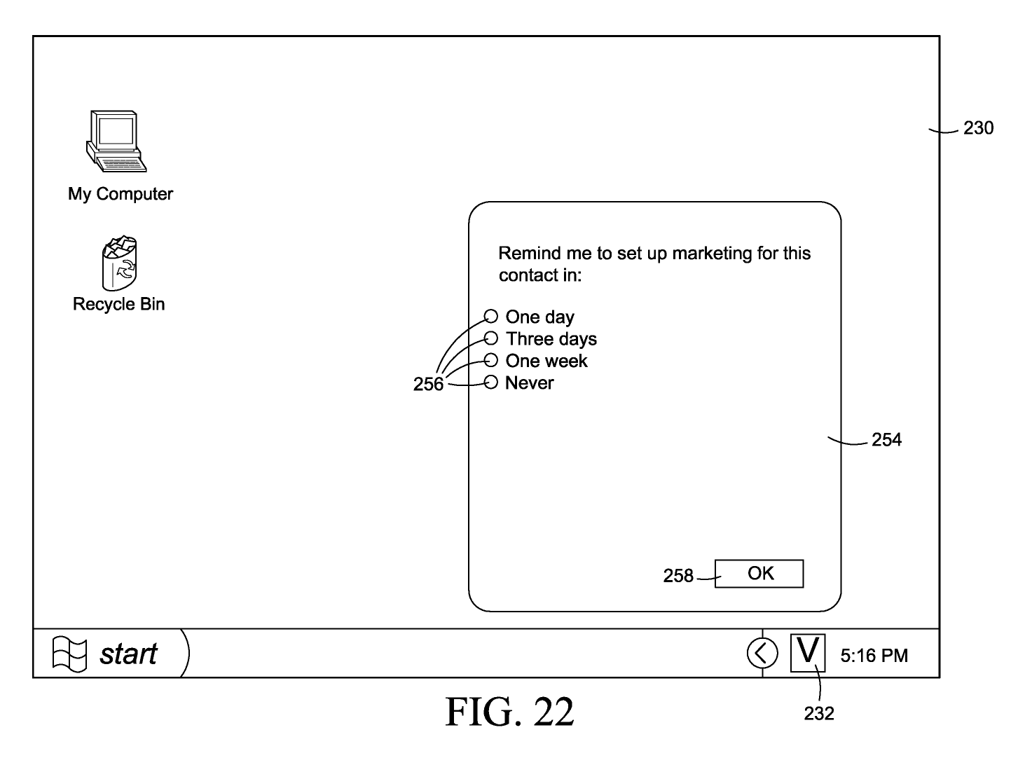

In FIG. 22 marketing agent 32 is displaying user interface content 254 received following a customer's selection of the “remind me later” button in FIG. 21. Content 254 includes controls 256 and 258 allowing the customer to select when to be reminded, if ever.

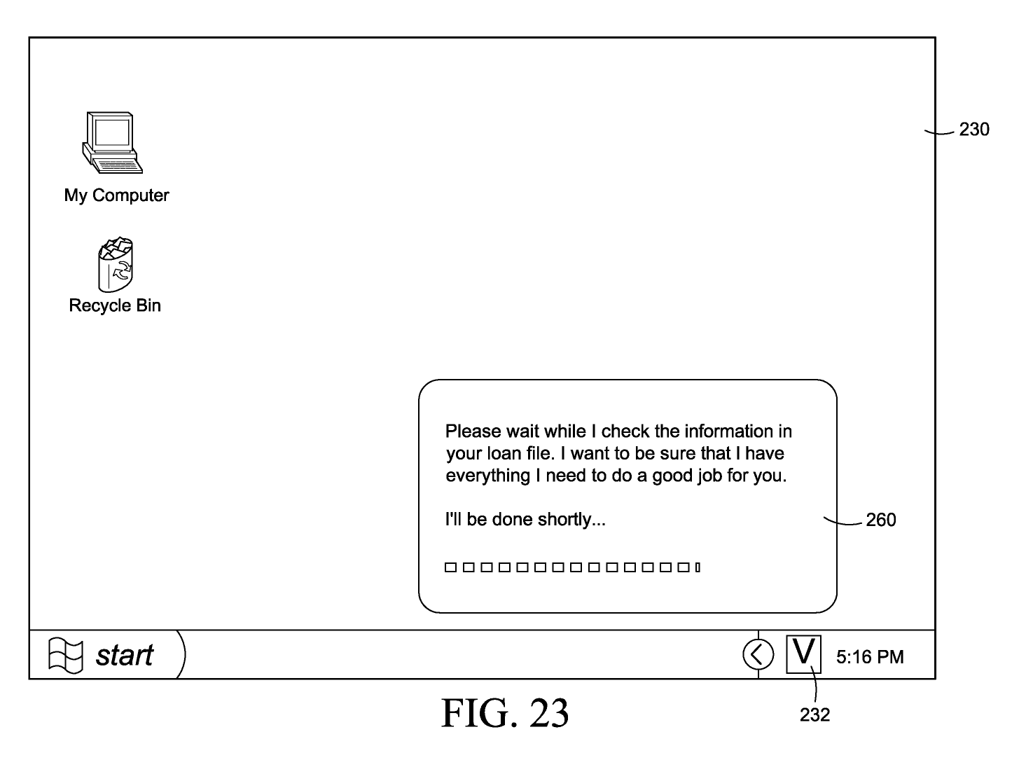

In FIG. 23 marketing agent 32 is displaying user interface content 260 received following a customer's selection of the “start marketing” button in FIG. 21. Content 260 informs the customer that marketing service 18 is examining the newly identified customer record 92 to determine if there is any missing contact information that is needed or would be useful to implement marketing actions selected in FIG. 21.

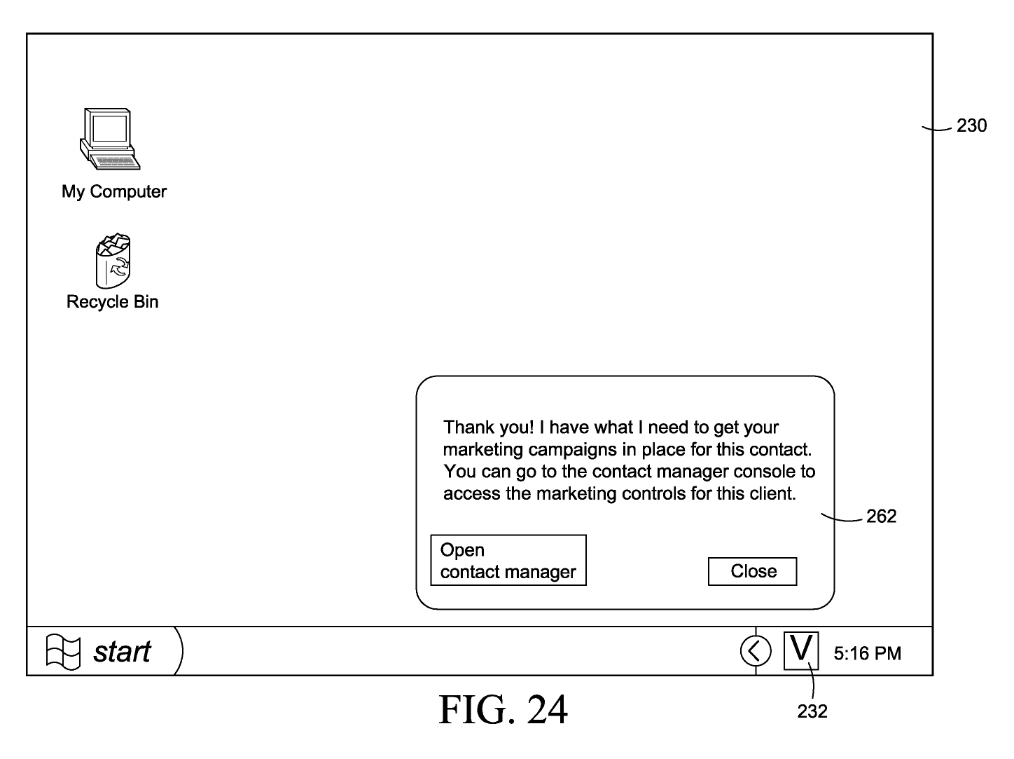

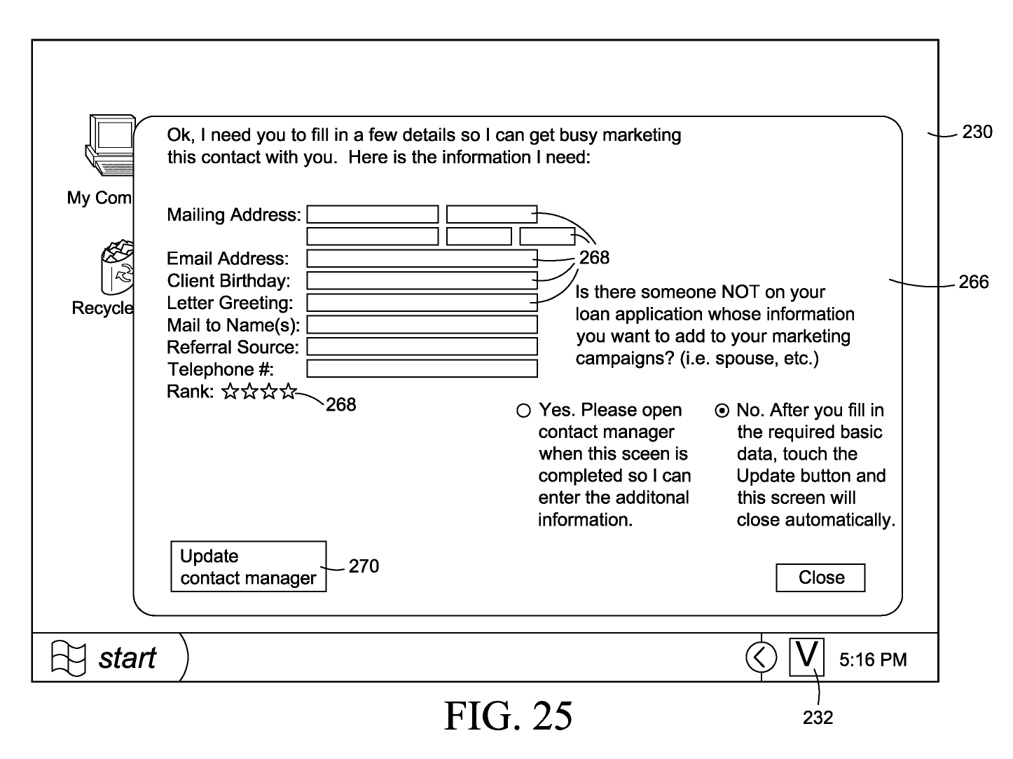

In FIG. 24, marketing agent 32 has received and is displaying user interface content 262 indicating that marketing service has not found any missing contact information. In FIG. 25, marketing service is displaying user interface content 266 received following a determination by marketing service 18 that the new contact record is missing some contact information. Content 266 includes controls 268 for inputting missing contact information and controls 270 for causing the updated information to be communicated to marketing service 270. In this example, a customer is given the opportunity to select a rank for a contact based on a system of one through four stars.

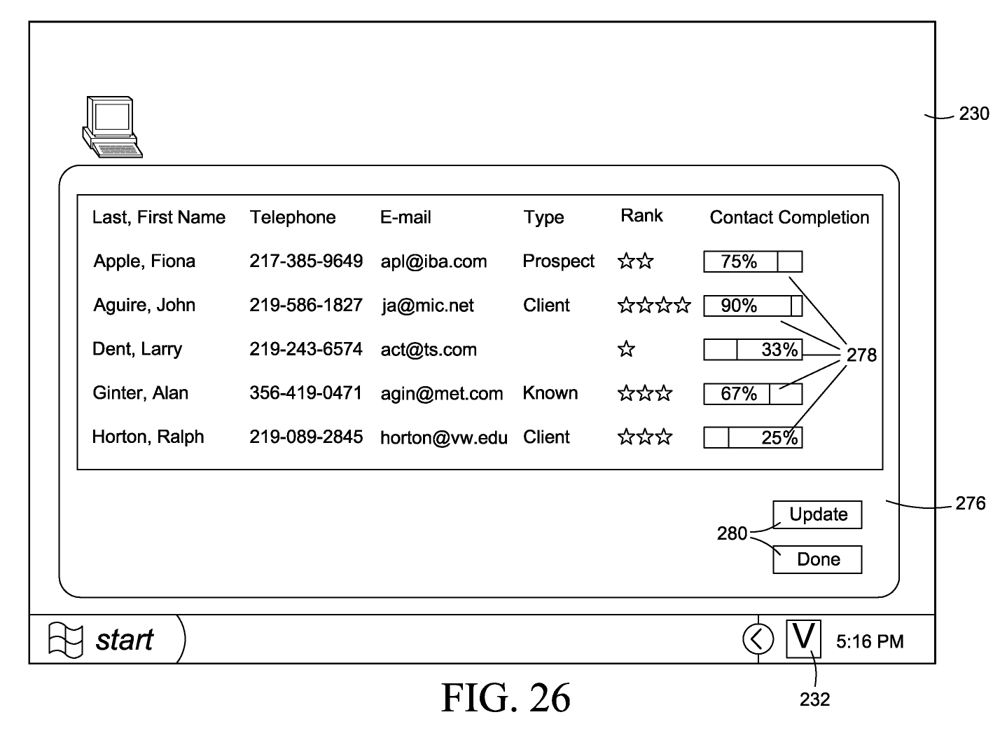

In FIG. 26, marketing agent 32 is displaying user interface content 276. Content 276 displays a list of contacts. That list includes the contact rank and a completion bar 278. The completion bar provides an indication of how much contact information is missing for a particular contact. The customer can select a contact from the list and then select the update control 280 to edit the contact information for that contact. Upon doing so, marketing agent might display user interface content for supplying contact information as shown in FIG. 25.

CONCLUSION: The schematic diagram of FIG. 1 illustrates an exemplary environment in which embodiments of the present invention may be implemented. Implementation, however, is not limited to this environment. The diagrams of FIGS. 2-12 show the architecture, functionality, and operation of various embodiments of the present invention. A number of the blocks are defined as programs. Each of those blocks may represent in whole or in part a module, segment, or portion of code that comprises one or more executable instructions to implement the specified logical function(s). Each block may represent a circuit or a number of interconnected circuits to implement the specified logical function(s).

Also, the present invention can be embodied in any computer-readable media for use by or in connection with an instruction execution system such as a computer/processor based system or an ASIC (Application Specific Integrated Circuit) or other system that can fetch or obtain the logic from computer-readable media and execute the instructions contained therein. “Computer-readable media” can be any media that can contain, store, or maintain programs and data for use by or in connection with the instruction execution system. Computer readable media can comprise any one of many physical media such as, for example, electronic, magnetic, optical, electromagnetic, or semiconductor media. More specific examples of suitable computer-readable media include, but are not limited to, a portable magnetic computer diskette such as floppy diskettes or hard drives, a random access memory (RAM), a read-only memory (ROM), an erasable programmable read-only memory, or a portable compact disc.

Although the flow diagrams of FIGS. 13-16 show specific orders of execution, the orders of execution may differ from that which is depicted. For example, the order of execution of two or more blocks may be scrambled relative to the order shown. Also, two or more blocks shown in succession may be executed concurrently or with partial concurrence. All such variations are within the scope of the present invention.

The present invention has been shown and described with reference to the foregoing exemplary embodiments. It is to be understood, however, that other forms, details and embodiments may be made without departing from the spirit and scope of the invention that is defined in the following claims.

What is claimed is:

1. A marketing method, comprising:
analyzing a customer contact database to identify action contacts;
generating a marketing plan for the action contacts, the marketing plan including a proposed action for each action contact;
communicating user interface content having controls for implementing the marketing plan and receiving selections entered using the user interface content;
analyzing the selections to identify marketing actions selected to be implemented;
assembling marketing jobs for the selected marketing actions; and
communicating each marketing job to a fulfillment vendor.

2. The method of claim 1, wherein generating comprises generating a marketing plan for the action contacts, the marketing plan including a proposed marketing action for each action contact, the proposed marketing action for each action contact being selected according to a ranking for that action contact.

3. The method of claim 1, further comprising identifying automatic marketing actions and wherein assembling marketing jobs for the selected marketing actions comprises assembling marketing jobs for the selected marketing actions and for the automatic marketing actions.

4. The method of claim 1, wherein assembling marketing jobs for the selected marketing actions comprises, for each marketing action:
selecting a fulfillment vendor for that marketing action;
identifying fulfillment requirements for the fulfillment vendor; and
generating job data according to the selected fulfillment requirements, the job data being interpretable by the identified fulfillment vendor in order to implement that marketing action.

5. The method of claim 4, wherein assembling marketing jobs for the selected marketing actions further comprises, for each marketing action, queuing a marketing job for that marketing action in a job queue, the marketing job including the job data and data identifying the identified fulfillment vendor.

6. The method of claim 5, wherein communicating each marketing job to a fulfillment vendor comprises:
monitoring the job queue for the presence of marketing jobs;
pulling a next marketing job from the job queue;
examining the next marketing job to identify the selected fulfillment vendor for that marketing job; and
communicating the next marketing job to the identified fulfillment vendor.

7. The method of claim 1, further comprising analyzing the customer contact database to identify missing contact data, if any, the missing contact information being needed to implement a marketing plan, if contact information is missing:
communicating user interface content having controls for supplying the missing contact information and receiving contact information supplied using the user interface content; and
updating the customer contact database with the received contact information.

8. The method of claim 7, further comprising, as new customer contact records are added to the customer contact database, repeating the acts of analyzing the customer contact database to identify missing contact data, communicating user interface content having controls for supplying the missing contact data, and updating the customer contact database with the received contact information.

9. The method of claim 7, wherein communicating user interface content having controls for supplying the missing contact information comprises communicating user interface content having controls for supplying a subset of the missing contact data, the method further comprising periodically repeating the acts of analyzing the customer contact database to identify missing contact data, communicating user interface content having controls for supplying a subset of the missing contact data, and updating the customer contact database with the received contact information.

10. A computer readable medium having computer executable instructions for:
analyzing a customer contact database to identify action contacts;
generating a marketing plan for the action contacts, the marketing plan including a proposed marketing action for each action contact;
communicating user interface content having controls for implementing the marketing plan and receiving selections entered using the user interface content;
analyzing the selections to identify marketing actions selected to be implemented;
assembling marketing jobs for the selected marketing actions; and
communicating each marketing job to a fulfillment vendor.

11. The medium of claim 10, wherein the instructions for generating include instructions for generating a marketing plan for the action contacts, the marketing plan including a proposed marketing action for each action contact, the proposed marketing action for each action contact being selected according to a ranking for that action contact.

12. The medium of claim 10, having further instructions for identifying automatic marketing actions and wherein the instructions for assembling marketing jobs for the selected marketing actions include instructions for assembling marketing jobs for the selected marketing actions and for the automatic marketing actions.

13. The medium of claim 10, wherein the instructions for assembling marketing jobs for the selected marketing actions include instructions for, for each marketing action:
selecting a fulfillment vendor for that marketing action;
identifying fulfillment requirements for the fulfillment vendor; and
generating job data according to the selected fulfillment requirements, the job data being interpretable by the identified fulfillment vendor in order to implement that marketing action.

14. The medium of claim 13, wherein the instructions for assembling marketing jobs for the selected marketing actions further include instructions for, for each marketing action, queuing a marketing job for that marketing action in a job queue, the marketing job including the job data and data identifying the identified fulfillment vendor.

15. The medium of claim 14, wherein the instructions for communicating each marketing job to a fulfillment vendor include instructions for:
monitoring the job queue for the presence of marketing jobs;
pulling a next marketing job from the job queue;
examining the next marketing job to identify the selected fulfillment vendor for that marketing job; and
communicating the next marketing job to the identified fulfillment vendor.

16. The medium of claim 10, having further instructions for analyzing the customer contact database to identify missing contact data, if any, the missing contact information being needed to implement a marketing plan, if contact information is missing:
communicating user interface content having controls for supplying the missing contact information and receiving contact information supplied using that user interface content; and
updating the customer contact database with the received contact information.

17. The medium of claim 16, having further instructions for, as new customer contact records are added to the customer contact database, repeating the execution of the instructions for analyzing the customer contact database to identify missing contact data, communicating user interface content having controls for supplying the missing contact data, and updating the customer contact database with the received contact information.

18. The medium of claim 16, wherein the instructions for communicating user interface content having controls for supplying the missing contact information include instructions for communicating user interface content having controls for supplying a subset of the missing contact data, the medium having further instructions for periodically repeating the execution of the instructions for analyzing the customer contact database to identify missing contact data, communicating user interface content having controls for supplying a subset of the missing contact data, and updating the customer contact database with the received contact information.

19. A marketing system, comprising a computer readable medium and a processor for executing instructions for stored on the computer readable medium wherein the computer readable medium includes instructions that when executed function as a plan builder, a job assemble, a user interface engine, and a fulfillment engine, wherein:
the plan builder is operable to analyze a customer contact database to identify action contacts and to generate a marketing plan for the action contacts, the marketing plan including a proposed marketing action for each action contact;
the user interface engines is operable to communicate user interface content having controls for implementing the marketing plan and to receive selections entered using the user interface content; and
the job assembler is operable to analyze the selections entered through the user interface content to identify marketing actions selected to be implemented and to assemble marketing jobs for the selected marketing actions; and
the fulfillment engine is operable to communicate each marketing job to a fulfillment vendor.

20. The system of claim 19, wherein the plan generator is operable to generate a marketing plan for the action contacts such that the proposed marketing action for each action contact is selected according to a ranking for that action contact.

21. The system of claim 19, wherein the plan generator is operable to identify automatic marketing actions and the job assembler is operable to assemble marketing jobs for the selected marketing actions and for the automatic marketing actions.

22. The system of claim 19, wherein the job assembler is operable to assemble marketing jobs for the selected marketing actions by, for each marketing action:
selecting a fulfillment vendor for that marketing action;
identifying fulfillment requirements for the fulfillment vendor; and
generating job data according to the selected fulfillment requirements, the job data being interpretable by the identified fulfillment vendor in order to implement that marketing action.

23. The system of claim 22, wherein the job assembler is operable to, for each marketing action, queue a marketing job for that marketing action in a job queue, the marketing job including the job data and data identifying the identified fulfillment vendor.

24. The system of claim 23, wherein the fulfillment engine is operable to:
monitor the job queue for the presence of marketing jobs;
pull a next marketing job from the job queue;
examine the next marketing job to identify the selected fulfillment vendor for that marketing job; and
communicate the next marketing job to the identified fulfillment vendor.

25. The system of claim 19, wherein the computer readable medium includes instructions that when executed function as a database engine, wherein the database engine is operable to:
analyze the customer contact database to identify missing contact data, if any, the missing contact information being needed to implement a marketing plan, if contact information is missing:
communicate user interface content having controls for supplying the missing contact information and receive contact information supplied using that user interface content; and
update the customer contact database with the received contact information.

26. The system of claim 25, wherein the database engine is operable to, as new customer contact records are added to the customer contact database, repeatedly analyze the customer contact database to identify missing contact data, communicate user interface content having controls for supplying the missing contact data, and update the customer contact database with the received contact information.

27. The system of claim 26, wherein the database engine is operable to communicate user interface content having controls for supplying a selected subset of the missing contact information and to periodically analyze the customer contact database to identify missing contact data, communicate user interface content having controls for supplying a subset of the missing contact data, and updating the customer contact database with the received contact information.
